(19) United States
(12) Patent Application Publication
(10) Pub. No.: US 2020/0183346 A1
(43) Pub. Date: Jun. 11, 2020

(54) METHOD FOR OPERATING A FIELD DEVICE IN THE FIELD OF AUTOMATION ENGINEERING

(71) Applicant: Endress+Hauser Flowtec AG, Reinach (CH)

(72) Inventors: Wolfgang Drahm, Erding (DE); Heinz Rufer, Dornach (CH); Ulrich Kaiser, Basel (CH); Nikolai Fink, Aesch (CH); Hartmut Breithaupt, Schwäbisch-Hall (DE); Martine Lefebvre, Blotzheim (FR)

(21) Appl. No.: 16/341,122

(22) PCT Filed: Aug. 29, 2017
(86) PCT No.: PCT/EP2017/071598

§ 371 Date: Apr. 11, 2019

(30) Foreign Application Priority Data
Oct. 11, 2016 (DE) 10 2016 119 338.0

(51) Int. Cl. G05B 19/042; G06F 8/38; G06F 9/451

(52) U.S. Cl. CPC G05B 19/042; G06F 9/451; G06F 8/38

(57) ABSTRACT

The present disclosure relates to a method for operating a field device in the field of automation engineering using an operating appliance with a homogeneously produced, application-specific user interface, the method including: a) connecting the operating appliance to the field device; b) inputting an application-specific request in the operating appliance; c) transmitting the specific request to the interpreter; d) sending data and procedures corresponding to the specific request back to the operating appliance; e) forwarding the data and procedures corresponding to the specific request from the operating appliance to the field device; f) implementing the data and procedures corresponding to the specific request in the field device; and g) the method continues with method steps b) to f), the specific request being determined by the interpreter according to the operator input.

The invention relates to a method for operating a field device in the field of automation engineering, as well as an automation system in the field of automation engineering.

Field devices for recording and/or modifying process variables are frequently used in process automation engineering, as well as in manufacture automation engineering. Measuring devices or sensors, such as level measuring devices, flow meters, pressure and temperature measuring devices, pH-redox potential meters, conductivity meters, etc., are used for recording the respective process variables such as fill-level, flow, pressure, temperature, pH level, and conductivity. Actuators, such as, for example, valves or pumps, are used to influence process variables. Thus, the flow rate of a fluid in a pipeline section or a fill-level in a container can be altered by means of actuators.

Field devices, in general, refer to all devices which are process-oriented and which supply or process process-relevant information. In addition to the aforementioned measuring devices in the form of sensors and actuators, units that are directly connected to a fieldbus and used for communication with higher-level units, such as remote I/O's, gateways, linking devices, and wireless adapters, are also generally referred to as field devices.

The field devices must be operated during operation of the field device with the field device operator. Ordinarily, operating appliances are used for this purpose. Such operating appliances are generally implemented here on a communications unit, separate from the corresponding field device, and have a communications link with the field device via an interface.

For this purpose, ordinary operating appliances are usually provided which present a relatively high resolution of information via a relatively large monitor and which enable a very precise selection of individual information by means of a pointer instrument—for example, a finger, a mouse, or a trackball.

A trend nowadays is that more and more mobile operating appliances are used which are equipped with a touch-sensitive input and/or display surface—for example, a touchscreen. Such touch-sensitive input and/or display surfaces are ordinarily operated with finger movements.

The multiplicity of different mobile operating appliances each with different input and/or display surfaces, on the one hand, and the different operating philosophies of the field device manufacturers for their field devices, as well as the multiplicity of different field device generations, leads to very complex operation of the field device by a user.

It is therefore an aim of the present invention to enable simplified operation of an automation field device.

The aim is achieved according to the invention by the method according to independent claim 1 and the automation system according to independent claim 9.

The method according to the invention for operating an automation field device by means of an operating appliance having a homogeneously-produced, application-specific user interface has at least the following method steps:
a) connecting the operating appliance to the field device;
b) determining an identity of the field device;
c) defining an application case;
d) connecting the operating appliance to an interpreter;
e) communicating the identity of the field device and of the defined application case to the interpreter;
f) selecting and activating the data and procedures required by the field device on the basis of the defined application case in the interpreter;
g) entering an application-specific request in the operating appliance;
h) transmitting the specific request to the interpreter;
i) sending data and procedures corresponding to the specific request back to the operating appliance;
j) forwarding the data and procedures, corresponding to the specific request, from the operating appliance to the field device;
k) implementing the data and procedures, corresponding to the specific request, in the field device;
l) continuing with method steps g) through k), wherein the specific request is determined by the interpreter according to the operator action.

An advantageous embodiment of the method according to the invention provides that the interpreter be implemented in a cloud.

An alternative embodiment of the method according to the invention provides that the interpreter be implemented in the operating appliance.

A further advantageous embodiment of the method according to the invention provides that the application case be defined by at least one of the following features:
a diagnostic case, in which the field device is subjected to a diagnosis;
a maintenance case, in which the field device is subjected to maintenance;
a service case, in which the field device is subjected to service;
a parameterization case, in which the field device is subjected to parameterization.
a measuring mode case, in which the field device is used for determining and/or monitoring an automation process variable.

A further advantageous embodiment of the method according to the invention provides that the interpreter request additional information with a first web service and use the additional information for determining the specific request for the field device. Nowadays, web services (sometimes also called web-based services) are used to provide a methodology capable of providing platform-independent services. Web-based services here means the processing of requests and return of responses in the sense of a “machine-to-machine” interaction.

An advantageous embodiment of the method according to the invention provides, in turn, that the interpreter transmit field device data from the field device to a second web service. In particular, the embodiment may provide that the field device data comprise diagnostic data of the field device and/or data for the purpose of operator statistics.

The automation system according to the invention comprises at least one field device, an operating appliance, and an interpreter, and is configured to implement the method according to one of the previously described embodiments.

The invention is explained in more detail based upon the following drawing. Shown is:

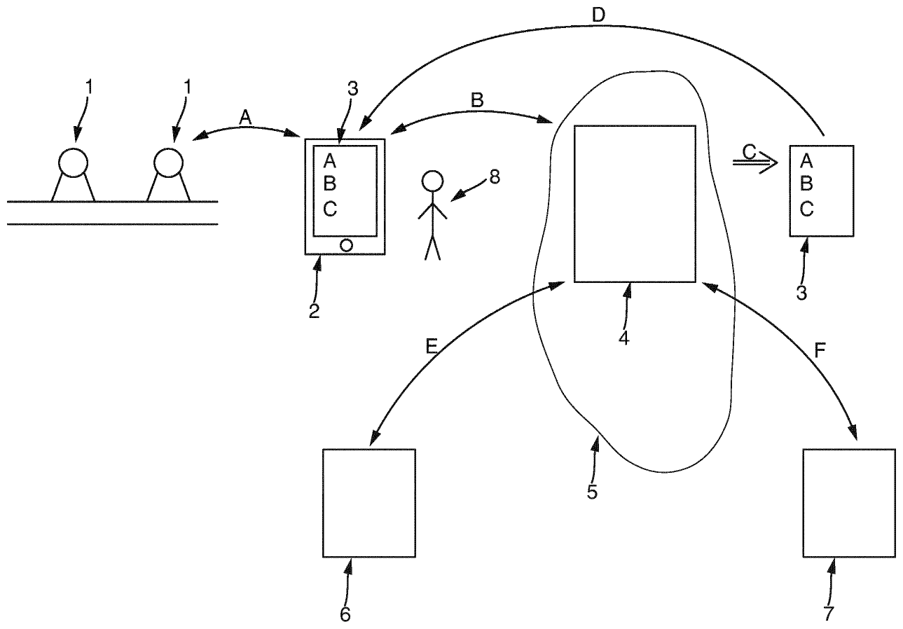

FIG. 1: a schematic illustration of an automation sensor.

FIG. 1 schematically shows an automation system, which typically comprises a plurality of field devices 1, an operating appliance 2, and an interpreter 4. FIG. 1 shows two field devices 1, simply by way of example, of which one field device 1 is connected to the operating appliance 2 for data transmission. The data-transmitting connection is indicated in FIG. 1 by the arrow designated by the letter “A” and can be implemented in both a wired and wireless manner. The mobile operating appliances mentioned at the outset, e.g., in the form of a mobile phone, a tablet computer, or similar mobile device, are preferably used here as operating appliance 2.

The operating appliance 2 offers a specific user interface 3 to the operator 8 for operation of the field device 1. The design of the user interface 3 depends, in the operating appliances known from the prior art, upon several factors. On the one hand, it depends upon the basic operating philosophy of the respective device manufacturer, but, on the other, it also depends upon the current device generation of the field device 1. In addition, the user interface 3 is oriented towards an intended application, so that the specific operating elements are available for the respective application case.

Examples of such application cases are:
a diagnostic case, in which the field device 1 is subjected to a diagnosis by an operator;
a maintenance case, in which the field device 1 is subjected to maintenance by an operator;
a service case, in which the field device 1 is subjected to service;
a parameterization case, in which the field device 1 is subjected to parameterization; and/or
a measuring mode case, in which the field device 1 is used for determining and/or monitoring an automation process variable.

In order to enable the operation of a field device 1 independently of the manufacturer of the respective field device and/or the field device generation, the method according to the invention includes providing a user interface 3 which, for all field devices 1, is uniformly adapted to the particular application case and runs on the operating appliance 2. Based upon the user interface 3 shown on the operating appliance 2, the operator can operate the field device 1 accordingly.

According to the invention, the following method steps are provided for this:
a) In the first method step, the operating appliance 2 connects to the field device 1 so as to transmit data. This can be accomplished in both a wired and wireless manner. This is indicated by way of example in FIG. 1 with the arrow “A.”
b) Then, the operating appliance 2 determines an identity of the field device 1.
c) In the next method step, the desired application is determined by the operator 8.
d) Thereafter, the operating appliance 2 connects to an interpreter 4. The interpreter 4 can be located either in the operating appliance 2 or else in a cloud 5. FIG. 1 shows the case in which the interpreter 4 is disposed in the cloud 5. The interpreter 4 may be implemented at the site where it is located and is connected to the operating appliance 2 so as to transmit data. This is indicated by way of example in FIG. 1 with the arrow “B.”
e) In the next method step, the previously determined identity of the field device 1 and the application case defined by the operator are communicated to the interpreter 4.
f) Based upon at least the predetermined application case, the interpreter 4, in the next method step, determines the data and procedures required by the field device 1 and activates them accordingly in the interpreter 4.
g) Next, an operator 8, for example, can enter an application-specific request in or on the operating appliance 2.
h) In the next step, the specific request is transmitted from the operating appliance 2 to the interpreter 4.
i) Thereafter, the interpreter 4 sends the data and procedures corresponding to the specific request back to the operating appliance 2. To define the data and procedures corresponding to the specific request, the interpreter 4 may request additional information from a first web service 6 (arrow “E”) and use the additional information to determine the data and procedures of the specific request for the field device 1.
j) After receiving the data and procedures, corresponding to the specific request, from the operating appliance 2, the operating appliance 2 forwards these data and procedures to the field device 1. The operating appliance 2 functions at this point as an intermediary or mediator, which is connected for data transmission to the interpreter 4, on the one hand, and to the field device 1, on the other. In the example shown by way of example in FIG. 1, this is indicated by the two arrows, “B” and “C.”
k) After obtaining the data and procedures corresponding to the specific request, the field device 1 implements them.
l) Then, the method steps g) through k) are again run through, wherein the specific request is determined by the interpreter 4 according to the operator action.

Furthermore, the method can include that the interpreter 4 transmits field device data from the field device 1, which have likewise been forwarded to the interpreter 4 via the operating appliance 2, to a second web service 7 (arrow “F”). The second web service 7 can thus be the same web-based service as in the case of the first web service 6, i.e., a manufacturer data bank hosted by a field device manufacturer, for example, or a web-based service different from the first web service 6. Examples of such field device data are diagnostic data of the field device and/or data which can be used to produce operator statistics.

1-8. (canceled)

9. A method of operating a field device in the field of process automation using an operating appliance, the method comprising:
a) connecting an operating appliance to a field device of process automation, wherein the operating appliance includes a homogeneously produced, application-specific user interface;
b) determining an identity of the field device;
c) defining an application case;
d) connecting the operating appliance to an interpreter;
e) communicating the identity of the field device and the defined application case to the interpreter;
f) selecting and activating data and procedures applicable to the field device based on the defined application case in the interpreter;
g) entering an application-specific request via the operating appliance;
h) transmitting the application-specific request to the interpreter;
i) sending the data and procedures corresponding to the specific request back to the operating appliance;
j) forwarding the data and procedures, corresponding to the application-specific request, from the operating appliance to the field device;
k) implementing the data and procedures, corresponding to the application-specific request, in the field device; and
l) continuing with method steps g) through k), wherein the application-specific request is determined by the interpreter according to operator input.

10. The method of claim 9, wherein the interpreter is implemented in a computing cloud.

11. The method of claim 9, wherein the interpreter is implemented in the operating appliance.

12. The method of claim 9, wherein the application case is defined by at least one of the following features:
a diagnostic case, in which the field device is subjected to a diagnosis;
a maintenance case, in which the field device is subjected to maintenance;
a service case, in which the field device is subjected to service;
a parameterization case, wherein the field device undergoes parameterization.
a measuring mode case, in which the field device is used for determining and/or monitoring a process variable.

13. The method of claim 9, wherein the interpreter requests additional information from a first web service and uses the additional information to determine the application-specific request for the field device.

14. The method of claim 9, wherein the interpreter transmits field device data from the field device to a second web service.

15. The method of claim 9, wherein the field device data includes diagnostic data of the field device and/or data for operator statistics.

16. An automation system, comprising:
at least one field device;
an operating appliance; and
an interpreter, wherein the system is configured to carry out the method according to claim 9.
